(19) United States
(12) Patent Application Publication
(10) Pub. No.: US 2010/0013773 A1
(43) Pub. Date: Jan. 21, 2010

(54) Keyboard apparatus integrated with handwriting retrieval function

(76) Inventor: Allen Ku, Walnut, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,171

(22) Filed: Jul. 17, 2008

(51) Int. Cl. G06F 3/02

(52) U.S. Cl. 345/168; 178/18.03

(57) ABSTRACT

A keyboard apparatus integrated with a function of retrieving handwriting tracks is disclosed. A handwriting retrieval module is disposed in the keyboard apparatus. The handwriting retrieval module helps users retrieve the data generated by tracing the handwriting in addition to input by keyboard. This keyboard apparatus integrated with the handwriting retrieval function implement a complete input solution.

### BACKGROUND OF THE INVENTION

1. Field of the Invention

The present invention relates to a keyboard apparatus integrated with handwriting retrieval function, more particularly to the keyboard apparatus with an embedded handwriting retrieval module, and to retrieve the handwriting information through wireless detection.

2. Description of Related Art

The keyboard is the most often used device for computer input, whereby users need to know well the arrangement of the keys for inputting data efficiently. Inputting language efficiently using a keyboard thus requires practice and skill, and for users not having the time or the skill required, keyboard input often remains cumbersome.

Therefore, a handwriting input method becomes a conventional solution of input. For example, users can use a stylus to write on a digital sensing tablet, and a character recognizing technology installed in a computer system is used to recognize the written characters, and record the handwriting tracks.

An example of a handwriting retrieval apparatus 10 of the prior art is shown in FIG. 1. This handwriting retrieval apparatus 10 is a conventional product that emits wireless signals and detects the reflective signals presenting the handwriting motions. Thereby, a real-time two-dimensional or three-dimensional wireless positioning and tracking technology is applied to the above purpose. The tracks written on the handwriting tablet 18 are detected and recorded. The handwriting retrieval apparatus 10 shown in the drawing includes a display screen 12 and a set of control keys 14. The display screen 12 shows the motions of the apparatus 10, or even the retrieved handwriting tracks. The control keys 14 at least have the keys with power start and mode configuration. It's not necessary to use the usual tablet for handwriting in this case.

Accordingly, as discussed above, the prior art still has some drawbacks that could be improved. The present invention aims to resolve the inconvenient way in the prior art.

### SUMMARY OF THE INVENTION

In order to integrate the conventional handwriting retrieval technology into the input apparatus of a computer system, the present invention provides a keyboard apparatus integrated with a handwriting retrieval function. Particularly, a module embodying the handwriting retrieval function is integrated with the keyboard apparatus. The handwriting retrieval module in common uses the power source supplied to the keyboard apparatus, and further uses the joint communication way exterior to outside. The user can utilize the handwriting retrieval module to record the handwriting information into the computer system in use of the keyboard apparatus.

The preferred embodiment of the keyboard apparatus integrated with the function of handwriting retrieval introduces a physical keyboard which includes an embedded keyboard controller for converting, transmitting and processing the key code received form a keyboard scan circuit. A communication unit outputs the signals generated by the keyboard controller to the computer system. The claimed keyboard apparatus further integrates a handwriting retrieval module.

The mentioned handwriting retrieval module includes a wireless detection unit for detecting the handwriting tracks, and a processing unit for processing and recognizing the tracks. A display unit can also be included for displaying the signal retrieving status and the recognized result through a screen. Further, a buffer memory unit is included to record the retrieved signals.

In particular, the operation of the stylus used in the handwriting retrieval module of the keyboard apparatus has at least three modes—a character recognizing mode, a handwriting drawing mode and a mouse mode.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic diagram of the conventional handwriting retrieval apparatus;

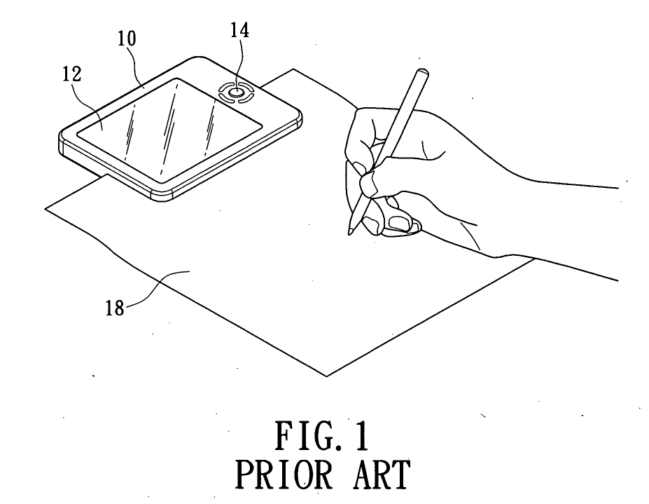

FIG. 2 shows a schematic diagram of the keyboard apparatus with handwriting retrieval function of the embodiment of the present invention;

FIG. 3 shows another schematic diagram of the claimed keyboard apparatus;

FIG. 4 shows a schematic diagram of the keyboard apparatus disposing a stylus of the embodiment;

FIG. 5 shows a block diagram of the claimed keyboard apparatus of the present invention.

### DETAILED DESCRIPTION

The present invention relates to a keyboard apparatus integrated with handwriting retrieval function. The handwriting retrieval function is modularized as a module integrated with the keyboard apparatus. The keyboard apparatus is functioned to provide an input method of a handwriting tablet without any specific input method in addition to the regular keyboard. This claimed keyboard is usually applied to the input apparatus of the computer system. In which, the handwriting retrieval module and the keyboard jointly use the power supply module. The power supply module can obtain the power through a communication interface to the computer system, or through the batteries installed inside the keyboard, or other power sources. The handwriting retrieval further uses the same communication way exterior to outside with the keyboard. After that, the user can use the handwriting retrieval function to input the handwriting information to the computer system as using the keyboard itself.

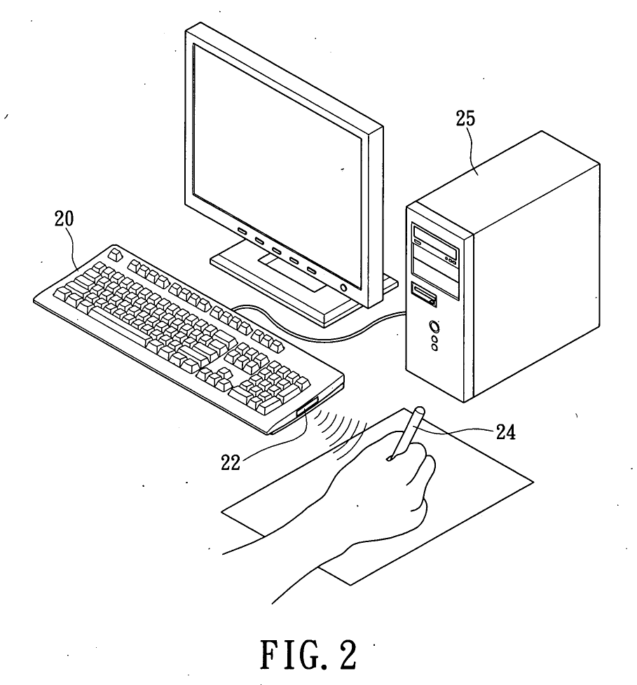

Reference is made to FIG. 2 showing one of the embodiments of the keyboard apparatus integrated with handwriting retrieval function. The keyboard apparatus 20 connects with a computer system 25, which is not limited as a desktop computer shown in the drawing, but the notebook computer and personal digital assistance (PDA) that are able to process data. A handwriting retrieval module 22 is installed in the keyboard apparatus 20. A window of wireless transceiver is shown exteriorly. The wireless signals able to determine the directions such as infrared rays, radio waves, supersonic wave, Bluetooth or their combination are transmitted through the window. For example, by means of the properties distinguished between the wireless signals, the handwriting tracks produced by the user using the stylus 24 can be recognized by determining the positions and progressing time of the stylus 24 as receiving the reflective signals. Particularly, the above track recognizing applies a real-time two-dimensional and three-dimensional wireless positioning and tracking technology. At last, the recognized signals are transmitted to the computer system 25 by the signaling means used between the keyboard apparatus 20 and the computer system 25.

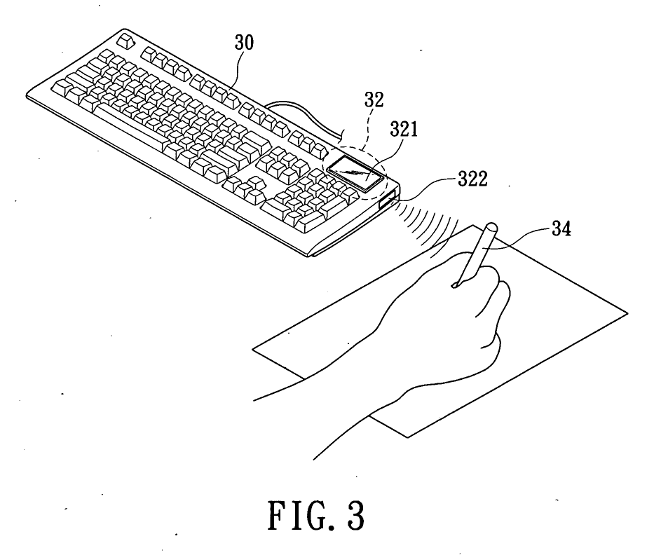

Further reference is made to FIG. 3, which shows another embodiment of the keyboard apparatus integrated with the handwriting retrieval function. Likewise the keyboard apparatus 30 is connected with the computer system (now shown), and a handwriting retrieval module 32 is preferably installed in a suitable position. A display screen 321 is further included in addition to a detector 322 being a wireless transceiver exteriorly included in the module 32.

The wireless signals are transmitted through the window of the detector 322, and the wireless signals can be generated by infrared rays, radio, supersonic wave, Bluetooth or the like. The position and the progressing time of the stylus 34 can be determined through the reflective signals, thereby the handwriting tracks produced by a user using the stylus 34 can be recognized. The display screen 321 displays the operating statuses of the apparatus 30, including the status of power, signal receiving, mode setting, and the result of recognizing the handwriting tracks or the characters. Those information is transmitted from the keyboard apparatus 30 to the computer system through the connection therebetween. The connection is implemented as USB, or the wireless connection such as Bluetooth, radio and the like.

More particularly, the operation of the handwriting retrieval module installed in the keyboard apparatus has at least three modes—a character recognizing mode, a handwriting drawing mode and a mouse mode.

When the handwriting retrieval module is configured to be the character recognizing mode, the wireless positioning and tracking technology is employed to retrieve the tracks for further character recognizing. Then the tracks will be recognized, especially to be a normal text format. The recognized result can further be transmitted to the computer system. The mentioned means for character recognizing is implemented through the firmware in a processor of the handwriting retrieval module, or alternatively through a recognizing program when the tracks are sent to the computer system. The recognized result can be applied to the text editing or amendment since the tracks are recognized and converted to the normal text format.

Next, when the handwriting retrieval module is configured to be the handwriting drawing mode, the mentioned wireless positioning and tracking technology is similarly employed. The retrieved handwriting tracks are also recognized and buffered in format of a pattern, and then transmitted to the computer system.

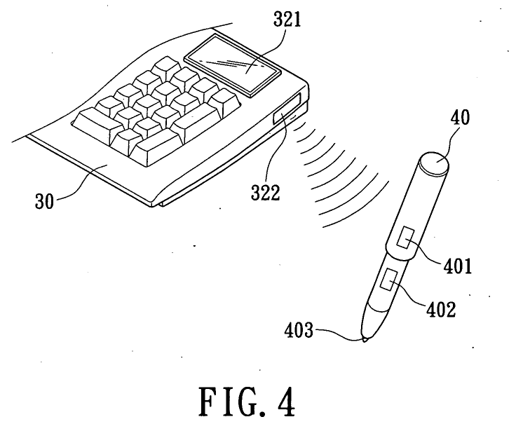

Moreover, when the handwriting retrieval module is configured to be in the mouse mode, the mentioned stylus 34 acts as a computer mouse. In this mode, the position of the computer pointer can be changed by recognizing the position of the stylus 34. Further, the buttons of the stylus 34 can be functioned as the right and left buttons or other keys of a computer mouse. The preferred embodiment of the stylus 34 is referred to FIG. 4.

FIG. 4 shows the embodiment of the stylus equipped on the keyboard apparatus with the handwriting retrieval function. The shown stylus 40 can be a device actively emitting signals. After that, the detector 322 is used to receive the wireless signals emitted from the stylus 40.

Moreover, a first button 401 and a second button 402 are disposed on the stylus 40, especially to be the right and left buttons of the computer mouse in the mouse mode. Or other keys disposed on the stylus 40 can be simulated for some special purposes.

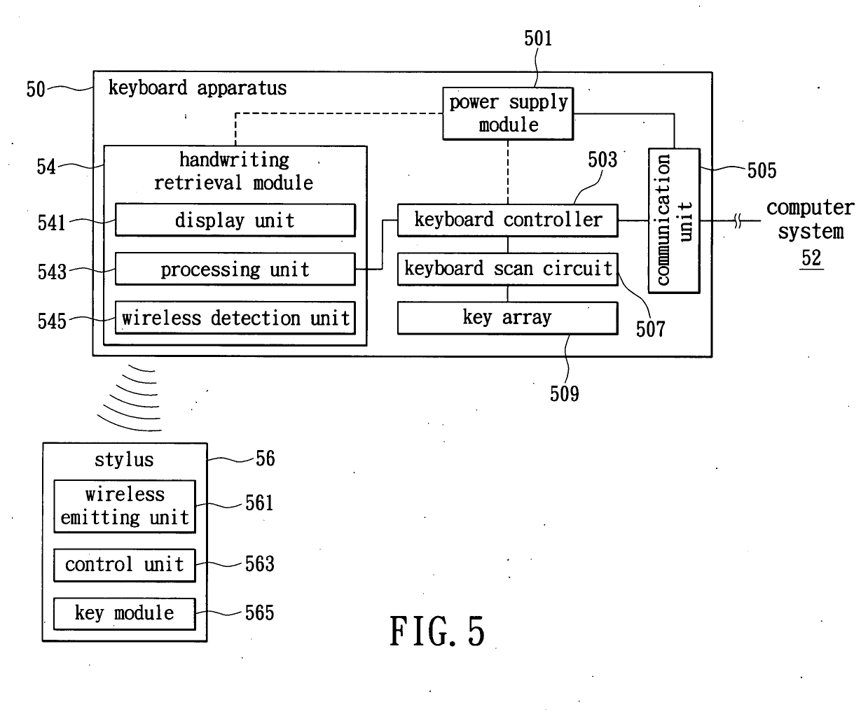

Further reference is made to FIG. 5 showing a circuitry block of the keyboard apparatus of the present invention. This preferred embodiment shows a keyboard apparatus 50 connected with a computer system 52. This apparatus 50 primarily has a handwriting retrieval module 54 and a keyboard controller 503. The handwriting retrieval module at least includes a processing unit 543 and a wireless detection unit 545, and moreover, a display unit 541 can be included. Moreover, the keyboard controller 503 is electrically connected with a power supply module 501, a communication unit 505, a keyboard scan circuit 507, and a key array 509 coupling to the keyboard scan circuit 507.

The mentioned keyboard controller 503 of the keyboard apparatus 50 is used to retrieve the scan codes that are produced by the key array 509 and received by the keyboard scan circuit 507, and convert the scan codes to other recognizable codes. After these processing steps, the codes are sent to a computer system (not shown) through the communication unit 505 of the keyboard controller 503. This communication unit 505 connects to the computer system with wired or wireless connection. According to the preferred embodiment of the present invention, the original keyboard module and the claimed handwriting retrieval module 54 are jointly use the communication unit 505, in other words, they jointly use the communication ports of the computer system. The signals sent from the keyboard apparatus 50 include the signals generated from the handwriting retrieval module 54 via the keyboard controller 503. Additionally, the original keyboard module and the handwriting retrieval module jointly use the power supply module 501 also. The power supply module 501 is used to manage the power source for the apparatus 50, and the power can be obtained from the computer system or keyboard's own batteries.

In particularly, the wireless detection unit 545 included in the handwriting retrieval module 54 is used to detect and retrieve the handwriting tracks. Then the wireless detection unit 545 transmits the wireless signals therefor and receives the signals reflected from the Stylus or actively sent from the stylus. Further, the received signals are processed in the processing unit 543 included in the handwriting retrieval module 54, and can be recognized as the tracks to be recorded. These handwriting tracks can be recognized as the normal texts through a recognizing program in form of firmware or being installed in the computer system.

Moreover, a stylus 56 can be included in the keyboard apparatus 50. The stylus 56 is electrically connected with the handwriting retrieval module 54 of the keyboard apparatus 50. Particularly, the stylus 56 can be a passive device, and the handwriting retrieval module 54 receives the wireless signals reflected from the stylus 56. Further the stylus 56's position and progressing time can be determined by these reflected signals. The stylus 56 can alternatively be an active device, as shown in the diagram, which includes a wireless emitting unit 561, control unit 563 and a key module 565.

In which, the wireless emitting unit 561 is used to generate wireless signals that can be received by the wireless detection unit 545 of the keyboard apparatus 50. The inside key module 565 acts as the combination of the right and the left buttons when it receives the keystroke from the user. The control unit 563, which is electrically connected with the wireless emitting unit 561 and key module 565, is used to generate the key signals by keystroke, such as the key codes. The key codes are then transmitted to the handwriting retrieval module 54 of the keyboard apparatus 50 via the wireless emitting unit 561.

Some relevant applications, such as the word processing software or drawing software, in the computer system are used to process the signals sent from the keyboard apparatus 50. In addition to have the key signals generated by the conventional keyboard module, the transmitting signals including the patterns and recognized texts produced by the handwriting retrieval module 54 are also received.

In the summation of above description, the claimed keyboard apparatus integrated with the function of retrieving handwriting is provided. Besides the users can key in by the keyboard, the handwriting method is further used to input data by the embedded handwriting retrieval module.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

What is claimed is:

1. A keyboard apparatus integrated with a handwriting retrieval function, comprising:
a keyboard controller used to convert a scan code received from a keyboard scan circuit, and to transmit the converted code;
a communication unit electrically connected with the keyboard controller, used to output the signals generated from the keyboard apparatus to a computer system;
a handwriting retrieval module electrically connected with the keyboard controller, further comprising:
a wireless detection unit used to detect and retrieve the handwriting tracks; and
a processing unit electrically connected with the wireless detection unit, used to receive the signals retrieved by the wireless detection unit, and to recognize the handwriting tracks.

2. The keyboard apparatus of claim 1, wherein the apparatus further comprises a stylus electrically connected with the handwriting retrieval module through wireless signals.

3. The keyboard apparatus of claim 2, wherein the stylus comprises:
a wireless emitting unit used to generate wireless signals that are received by the wireless detection unit;
a key module used to receive a keystroke instruction; and
a control unit electrically connected with the wireless emitting unit and the key module, used to receive a keystroke signal by the keystroke instruction, and transmit the keystroke signal through the wireless emitting unit.

4. The keyboard apparatus of claim 1, wherein the handwriting retrieval module has a character recognizing mode, a handwriting drawing mode, and a mouse mode.

5. The keyboard apparatus of claim 4, wherein the handwriting retrieval module uses the processing unit to recognize characters, and transmit the result in the character recognizing mode.

6. The keyboard apparatus of claim 4, wherein the handwriting retrieval module uses the processing unit to recognize and record the handwriting tracks, and transmit the result in the handwriting drawing mode.

7. The keyboard apparatus of claim 4, wherein the handwriting retrieval module controls a pointer position of the computer system by recognizing the position of a stylus in the mouse mode.

8. The keyboard apparatus of claim 1, wherein the handwriting retrieval module installs a display unit electrically connected with the processing unit for displaying the retrieval status and the recognized result.

9. The keyboard apparatus of claim 1, wherein the handwriting retrieval module further installs a buffer memory unit electrically connected with the processing unit for buffering retrieved signals.

10. The keyboard apparatus of claim 1, wherein the signals generated by the handwriting retrieval module are transmitted to the computer system through the keyboard controller and the communication unit.

11. The keyboard apparatus of claim 10, wherein the communication unit transmits the signals to the computer system via wired or wireless communication.

12. A keyboard apparatus integrated with a handwriting retrieval function, comprising:
a keyboard controller used to convert a scan code received from a keyboard scan circuit, and to transmit the converted code;
a communication unit electrically connected with the keyboard controller, used to output the signals generated from the keyboard apparatus to a computer system;
a handwriting retrieval module electrically connected with the keyboard controller, the signals generated by the handwriting retrieval module being transmitted to the computer system through the keyboard controller and the communication unit, the handwriting retrieval module further comprising:
a wireless detection unit used to detect and retrieve the handwriting tracks;
a processing unit electrically connected with the wireless detection unit, used to receive the signals retrieved by the wireless detection unit, and to recognize the handwriting tracks;
a display unit electrically connected with the processing unit, used to display receiving status and the recognized result; and
a stylus electrically connected with the handwriting retrieval module via wireless communication.

13. The keyboard apparatus of claim 12, wherein the handwriting retrieval module has a character recognizing mode and a handwriting drawing mode.

14. The keyboard apparatus of claim 13, wherein the handwriting retrieval module uses the processing unit to recognize characters, and transmit the result in the character recognizing mode.

15. The keyboard apparatus of claim 13, wherein the handwriting retrieval module uses the processing unit to recognize and record the handwriting tracks, and transmit the result in the handwriting drawing mode.

16. The keyboard apparatus of claim 12, wherein the communication unit transmits the signals via wired or wireless communication.

17. The keyboard apparatus of claim 12, wherein the handwriting retrieval module further installs a buffer memory unit electrically connected with the processing unit for buffering the received signals.

18. The keyboard apparatus of claim 12, wherein the stylus comprises:
a wireless emitting unit used to generate wireless signals that are received by the wireless detection unit;
a key module used to receive a keystroke instruction; and
a control unit electrically connected with the wireless emitting unit and the key module, used to receive a keystroke signal generated by the keystroke instruction, and transmit the signal through the wireless emitting unit.
